(19) United States
(12) Patent Application Publication
(10) Pub. No.: US 2004/0017619 A1
(43) Pub. Date: Jan. 29, 2004

(54) Adjusting apparatus for an optical device

(75) Inventor: Chih-Chung Kang, Hsinchu (TW)

Correspondence Address: BACON & THOMAS, PLLC, 625 SLATERS LANE, FOURTH FLOOR, ALEXANDRIA, VA, 22314

(73) Assignee: Coretronic Corporation, Hsinchu (TW)

(21) Appl. No.: 10/602,647

(22) Filed: Jun. 25, 2003

(30) Foreign Application Priority Data
Jul. 23, 2002 (TW) 91211412

(51) Int. Cl. G02F 1/33; G02B 7/02

(52) U.S. Cl. 359/822; 359/823; 359/813

(57) ABSTRACT

The present invention is an adjusting apparatus for an optical devices. The optical device is fixed on a carrier attached onto a sliding plate. Both sides of the carrier respectively connect with springs and a cable. The other end of the cable is from X-axis adjusting knob. In the same way, the sliding plate is attached onto a base plate being installed into a pair of sliding rails. Both sides of the base plate respectively connect with springs and a cable. The other end of the cable is from Y-axis adjusting knob. The base plate is attached into a bottom case. The upper and lower surfaces of the bottom case respectively connect with springs and a cable. The other end of the cable is from Z-axis adjusting knob. According to the mechanism of the present invention, the optical devices can be quickly and precisely aligned with three-dimension.

### BACKGROUND OF THE INVENTION

1. Field of the Invention

The present invention relates to an adjusting apparatus for an optical device, and more particularly to an adjusting apparatus for an optical device adapted for use in a projection display system.

2. Description of the Related Art

As known, the relative position of optical devices using in a projection display system will affect the precision of a projective beam directly. Therefore, during the fabricating process, the optical devices must be micro-adjusted to obtain a high quality image.

Referring to FIG. 1, a conventionally known adjusting apparatus 10 for an optical device is used in a projection display system. The known adjusting apparatus 10, by adjusting a X-axis mechanism and a Y-axis mechanism, adjusts an optical device 11 (mirror, lens, panel, etc . . . ) from its initial position to a desired position. In adjusting apparatus 10, the optical device 11 is fixed to a fixed frame 12, and the fixed frame 12 is attached onto a sliding frame 13. Then, the sliding frame13 is installed on a guided plate 14 by letting 4 locators 141 of the guided plate 14 go through 4 guide slots 131 of the sliding frame13, and thus the sliding frame 13 is moved along the X-axis direction only. One side of the sliding frame 13 is connected with a ledge132having a bolt hole 133. A support 142 on the one side of the guided plate 14 is corresponded to the bolt hole133. There is a slot 143in the support142. By adjusting a knob15 mounted on the slot 143 and engaged with the bolt hole133, the sliding frame13 with the optical device 11 is longitudinally guided along the X-axis direction. Furthermore, a carrier base 16, whose 4 positioning holes 161 pass through the locators141, is positioned on the other side of the guided plate 14. A sliding plate 17 is positioned onto the carrier base 16. 4 inclined slots 171 on the sliding plate 17, passing through the locator 141, are vertically moved along the Y-axis direction. One side of the carrier base 16 is connected with a ledge162, and a bolt hole 163 is in the ledge162. A support 172 on one side of the sliding plate 17 is corresponded to the ledge 162. There is a slot 173 in the support 172. By adjusting a knob 18 mounted on the slot 173 and engaged with the bolt hole 163, the carrier base16 carrying the guided plate 14, the sliding frame13, and the fixed frame 12 is driven to move the optical device 11 vertically along the Y-axis direction.

The above-mentioned adjusting apparatus10 just can be adjusted to move the optical device 11 in two-dimensional direction, but can't be adjusted in the three-dimensional position. After adjusting, those knobs 15 and 18 also need to be stuck with glue for fixing. In addition, those knobs 15 and 18 have to be disposed separately at two-dimensional directions, which the optical device 11 is moved along, so as to adjust the optical device 11. However, In general, a projection display system is tightly replete with various and required components inside, and the space for maintaining or adjusting is limited. As the result, the adjustment of the optical device 11 is not only restricted by the limited space to increase the difficulty in adjustment, but also the alignment of the projection display system becomes more complicated so that the compact can not be achieved.

### SUMMARY OF THE INVENTION

An object of the present invention is to provide an adjusting apparatus for an optical device for adjusting the three-dimensional position.

Another object of the present invention is to provide an adjusting apparatus for an optical device for positioning adjusting knobs together in fitting and proper position to make adjustment more convenient.

Another object of the present invention is to provide an adjusting apparatus with cables. By use of the winding character of cables, the adjusting apparatus could be more free to arrange the alignment in three-dimension and raise the endurance of adjusting precision.

To achieve the above and other objects, the optical device is fixed on a carrier attached onto a sliding plate. Both sides of the carrier respectively connect with springs and a cable. The other end of the cable is from X-axis adjusting knob. In the same way, the sliding plate is attached onto a base plate being installed into a pair of guiding rails. Both sides of the base plate respectively connect with springs and a cable. The other end of the cable is from Y-axis adjusting knob. The base plate is attached into a bottom case. The upper and lower surfaces of the bottom case respectively connect with springs and a cable. The other end of the cable is from Z-axis adjusting knob. According to the mechanism of the present invention, the X-axis adjusting knob, the Y-axis adjusting knob, and the Z-axis adjusting knob can be positioned in the same side of the adjusting apparatus to adjust the optical devices conveniently in three-dimension.

### BRIEF DESCRIPTION OF THE DRAWINGS

The above and other objects, advantages, and features of the present invention will be understood from the following detailed description of the invention when considered in connection with the accompanying drawings below.

FIG. 1 is a schematic perspective view showing a prior art.

FIG. 2 is a schematic view showing the one-dimension adjusting apparatus of the present invention.

FIG. 3 is a schematic view showing the first embodiment of the present invention.

FIG. 4 is a cross-sectional view taken along line A-A of FIG. 3

FIG. 5 is a schematic view showing the second embodiment of the present invention.

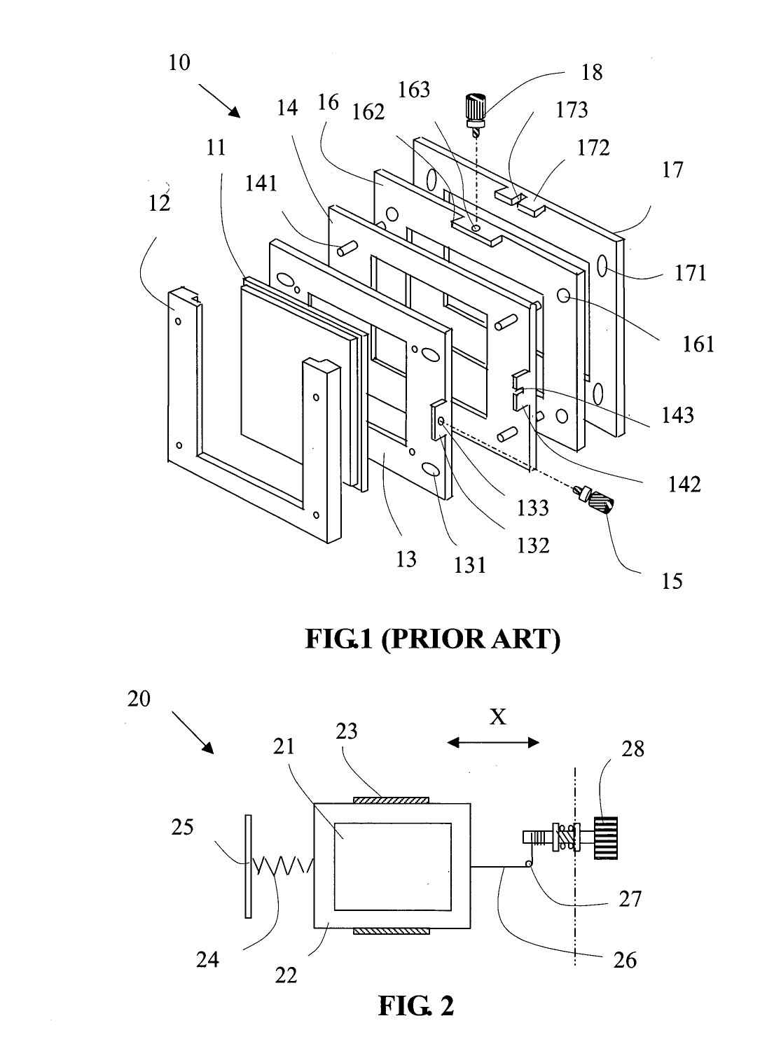

### DETAILED DESCRIPTION OF THE INVENTION

Referring to FIG. 2 which shows a adjusting apparatus 20 of the present invention, the one-dimension adjusting method of the present invention is described first. An optical device 21 is fixed on a carrier 22. The carrier 22 is installed into a pair of guide rails 23 and, thus, the carrier 22 is longitudinally moved along the X-axis. One side of the carrier 22 is connected with a spring 24. The other end of the spring 24 is connected to a fixed plate 25. The other side of the carrier 22 is connected to a cable 26. The other end of the cable 26, transferring the direction by a bolt 27, is directed to and winds around an adjusting knob 28, such as a ratchet.

As described above, by rotating the adjusting knob 28, the cable 26 is strained to draw the carrier 22 which the optical device 21 is fixed on, and the carrier 22 slides right along the guide rails 23. On the contrast, when pressing the adjusting knob 28 for releasing the rotational limit to loose the cable 26, the carrier 22 carrying the optical device 21is drawn left by the spring 24 along the guide rails 23. Then, the position of the carrier 22 could be longitudinally adjusted along the one-dimension.

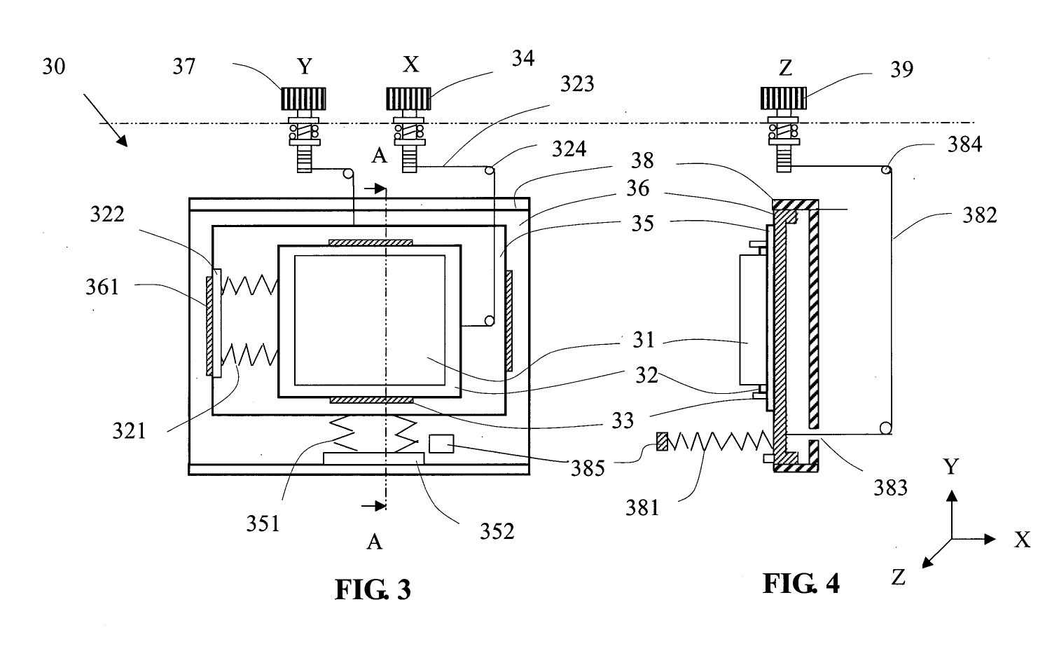

Referring to FIGS. 3 and 4, according to the mechanism of the above-mentioned one-dimension adjusting apparatus 20, a preferred embodiment of the present invention is to provide an adjusting apparatus 30 for adjusting the three-dimensional position. An optical device 31 is fixed on a carrier 32. The carrier 32 is attached on a sliding plate 35. A pair of guide rails 33 positioned in Y-axis direction is installed on the sliding plate 35 and, thus, the carrier 32 is longitudinally guided to move along the X-axis direction. One side of the carrier 32 is connected with at least one spring 321 in X-axis direction. The other end of the spring 321 is connected to a support 322 fixed on the edge of the sliding plate 35, and the support 322 and the spring 321 are on the same side of the sliding plate 35. The other side of the carrier 32 is connected to a cable 323. The other end of the cable 323, transferring the direction by bolts 324, is directed to and winds around an X-axis adjusting knob 34 having a function of a ratchet.

The sliding plate 35 is placed on a base plate 36. A pair of guide rails 361 positioned in X-axis direction is installed on the base plate36and, thus, the carrier 32 is vertically guided to move along the Y-axis direction. The lower side of the sliding plate 35 is connected with at least one spring 351. The other end of the spring 351 is connected to a support 352 fixed on the edge of the base plate 36, and the support 352 and the spring 351are on the same side of the base plate 36. The upper side of the sliding plate35 is connected to a cable 353. The other end of the cable 353 is directed and winds around a Y-axis adjusting knob 37 having a function of a ratchet.

The base plate 36 is mounted into a bottom case 38 and, thus, the base plate 36 is guided to move along the Z-axis direction. Upper surface of the base plate 36 is connected with at least one spring 381. The other end of the spring 381 is connected to a support 385 fixed over the base plate 36. The down side of the base plate 36 is connected to a cable 382. The other end of the cable 382, through a thread hole 383 of the bottom case 38 and transferring the direction by bolt 384, is directed to and winds around a Z-axis adjusting knob 39. The adjusting knob 39 could be a ratchet button for releasing rotational limit by pressing it. By means of the same adjusting method as the above-mentioned one-dimension adjusting method, we could adjust the X-axis adjusting knob34, Y-axis adjusting knob37, and Z-axis adjusting knob39 to drive the spring321, the spring351, and the spring 381 by the cable353, cable323, and cable382. The optical devices31 can be quickly and precisely aligned with three-dimension. Furthermore, we could set the X-axis adjusting knob 34, Y-axis adjusting knob 37, and Z-axis adjusting knob 39 in the same side. It is advantageous to adjust the adjusting apparatus 30 in a limited space after assembling.

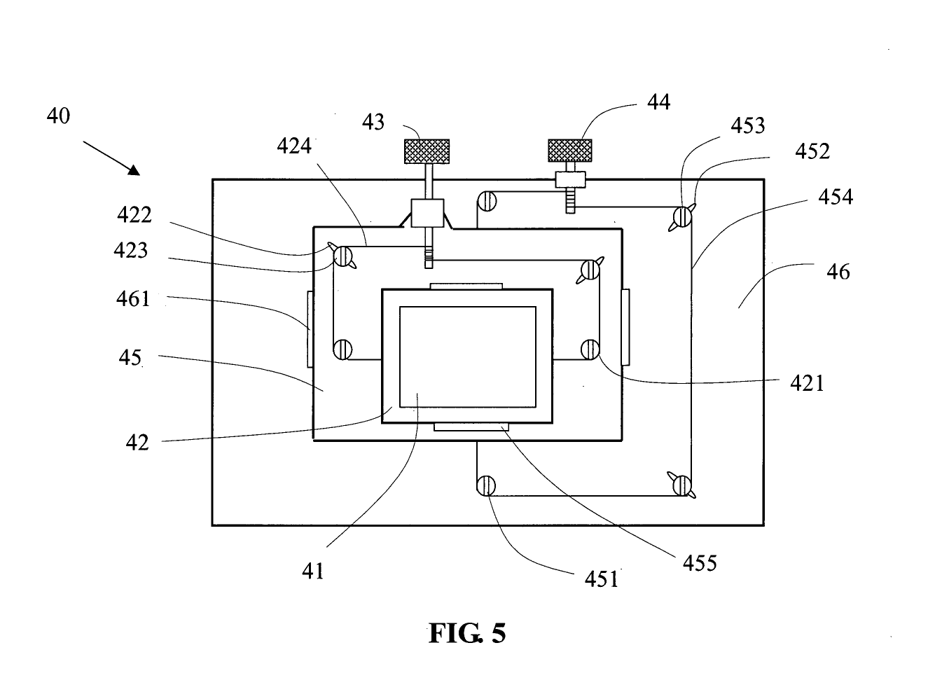

Referring to the drawing FIG. 5, another embodiment of the present invention is to provide an adjusting apparatus 40 for an optical device 41. The optical device 41 is fixed on a carrier 42. The carrier 42 is attached on a sliding plate 45. A pair of guide rails 455 positioned in Y-axis direction is installed on the sliding plate 45 and, thus, the carrier 42 is longitudinally guided to move along the X-axis direction. Transferring bolts 421 are placed beside both sides of the carrier 42. Threading holes 422 are disposed within the upper portion of the sliding plate45. Each threading hole22 is aligned with each transferring bolt 21 vertically. The threading hole 422 further includes a tension adjusting bolt 423. An X-axis adjusting knob 43 is placed upper the sliding plate 45. A cable 42 is winded around the X-axis adjusting knob 43. Each end of the cable 42, transferring the direction by the transferring bolt 421 and the tension adjusting bolt 423, is connected to the each side of the carrier 42.

Moreover, The sliding plate45 is attached onto a base plate46. A pair of guide rails 461 positioned in X-axis direction is installed on the base plate 46 and, thus, the sliding plate45 is vertically guided to move along the Y-axis direction. Transferring bolts 451 are placed beside both sides of the sliding plate 45. Threading holes 452 disposed on the base plate 46 have the same level as transferring bolts 451 separately. The threading hole 452 further includes a tension adjusting bolt 453. An Y-axis adjusting knob44 is placed upper the base plate 46. A cable454 is winded around the Y-axis adjusting knob44. Each end of the cable454, transferring the direction by the transferring bolt 453 and the tension adjusting bolt 451, is connected to the upper and lower side of the sliding plate 45. According to the adjusting apparatus40 of the present invention, we could set the X-axis adjusting knob 43 and Y-axis adjusting knob 44 in the same side. It is advantageous to adjust the adjusting apparatus in a limited space after assembling. By rotating the X-axis adjusting knob 43, the cable 424 is released from one side of the X-axis adjusting knob 43 and strained from another side. Then, the cable 424 transfers the direction by the transferring bolts 421and the tension adjusting bolts 423 for drawing the carrier 42 carrying the optical device 41 to move along the X-axis direction. The carrier 42 could be guided along the X-axis direction through the guide rails 455. In the same way, by adjusting the Y-axis adjusting knob 44, the cable 454 transfers the direction by the transferring bolt 451 and the tension adjusting bolt 453 for drawing the sliding plate 45 to move along the Y-axis direction. The sliding plate 45 could be guided along the Y-axis direction through the guide rails 461.

Additionally, in the adjusting apparatus 40, we could adjust the position of the tension adjusting bolts 423 and the tension adjusting bolts 453 for achieving suitable tension to maintain the precision position of the optical device 41 lastingly. Thus, the adjusting apparatus 40 can avoid that the precision position of the optical device 41 is deteriorating from the fatigue of the springs 321and 351, resulting from the use of the springs for a long time. According to the above-mentioned adjusting apparatus 40 of the present invention, we could infer the mechanism of Z-axis apparatus to construct a three-dimension adjustment for the optical devices41. This mechanism do not depart from the spirit of the invention, and shall be included in the subject claim.

While a preferred and particular embodiment of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. An adjusting apparatus for an optical device comprising:
an optical device;
a carrier which said optical device is fixed on;
a sliding plate which said carrier is attached on, a support which is positioned beside said carrier in the X-axis direction and fixed on a edge of said sliding plate, at least one spring connecting between said carrier and said support;
a X-axis adjusting knob which is winded by a cable, said cable connecting to one side of said carrier;
a base plate which is attached on said sliding plate, a support being positioned beside said sliding plate in Y-axis direction and fixed on a edge of said base plate, at least one spring connecting between said support and said sliding plate; and
a Y-axis adjusting knob which is winded by a cable, said cable connecting to the other side of said sliding plate.

2. An adjusting apparatus of in claim 1 wherein said base plate installed into a bottom case, the upper surface of said base plate connecting to at least a spring, the other end of said spring connecting to a solid, the down surface of said base plate connecting to a cable, said cable extending through an opening in said bottom case and connecting to a Z-axis adjusting knob.

3. An adjusting apparatus of claim 2 wherein said X-axis adjusting knob, said Y-axis adjusting knob, and said Z-axis adjusting knob are ratchets for releasing rotational limit by pressing.

4. An adjusting apparatus of claim 2 further comprising at least one bolt which said cables are transferred the direction by.

5. An adjusting apparatus of claim 4 wherein said X-axis adjusting knob, said Y-axis adjusting knob, and said Z-axis adjusting knob position in the same side of the adjusting apparatus.

6. An adjusting apparatus of claim 1 further comprising a pair of guide rails which are positioned in the Y-axis from each side of said carrier longitudinally moved along the X-axis.

7. An adjusting apparatus of claim 1 wherein further comprising a pair of guide rails which are positioned in the X-axis from each side of said sliding plate vertically moved along the Y-axis.

8. An adjusting apparatus of claim 2 wherein said base plate is installed into said bottom case and, thus, said bottom case plate is moved along the Z-axis.

9. An adjusting apparatus for an optical device comprising:
an optical device;
a carrier which said optical device is fixed on;
a sliding plate which said carrier is attached on,
a pair of bolts being positioned beside each side of said carrier longitudinally;
a X-axis adjusting knob which is fixed on said sliding plate and winded by a cable, each end of said cable, passing by said bolts, respective connecting to the both sides of said carrier in X-axis direction;
a base plate which said sliding plate attached to,
a pair of bolts being positioned beside each side of said sliding plate vertically; and
a Y-axis adjusting knob which is fixed on said base plateand winded by a cable, each end of said cable, passing by said bolts, respective connecting to the both sides of said carrier in Y-axis direction.

10. An adjusting apparatus of claim 9 wherein said X-axis adjusting knob and said Y-axis adjusting knob are positioned in the same side of the adjusting apparatus.

11. An adjusting apparatus of claim 9 further comprising at least one tension adjusting bolt in a inclined threading hole, said cables passing through said tension adjusting bolt.

12. An adjusting apparatus of claim 9 further comprising a pair of guide rails being positioned in the Y-axis from each side of said carrier longitudinally moved along the X-axis.

13. An adjusting apparatus of claim 9 further comprising a pair of guide rails being positioned in the X-axis from each side of said sliding plate vertically moved along the Y-axis.
